(19) United States
(12) Patent Application Publication
(10) Pub. No.: US 2024/0354291 A1
(43) Pub. Date: Oct. 24, 2024

(54) DATA MIGRATION

(71) Applicant: Wells Fargo Bank, N.A., San Francisco, CA (US)

(72) Inventors: Kasiperumal Achappan, Bengaluru (IN); Ramya Balasubramanian, Telangana (IN); Chintan Mehta, San Ramon, CA (US); Harish Mohan, Bangalore (IN); Poornimadevi Pandurangan, Bangalore (IN); Ajay Kumar Panikkar, Sunnyvale, CA (US); Ramakrishna Swarup Pogalur, San Ramon, CA (US); Suresh Reddy, Hyderabad (IN); Ravi Kanth Thota, San Francisco, CA (US)

(21) Appl. No.: 18/302,485

(22) Filed: Apr. 18, 2023

(51) Int. Cl. G06F 16/21; G06F 16/23; G06F 16/27

(52) U.S. Cl. CPC G06F 16/214; G06F 16/2365; G06F 16/27

(57) ABSTRACT

An example computer system for migration of information can include: one or more processors; and non-transitory computer-readable storage media encoding instructions which, when executed by the one or more processors, causes the computer system to create: a synchronization module programmed to migrate data from a source data store to a target data store, wherein the synchronization module is configured to control how much of the data is migrated; and a validation module programmed to validate the data between the source data store and the target data store.

### BACKGROUND

As part of modernization or migration to the cloud, existing applications may move away from legacy technology stacks (e.g., monolith, relational data store management systems) to modern technology stacks (e.g., microservice, document data store or column data store). One typical prerequisite to performing this migration is transferring the associated data from one data store to another.

### SUMMARY

Examples provided herein are directed to data migration.

According to one aspect, an example computer system for migration of information can include: one or more processors; and non-transitory computer-readable storage media encoding instructions which, when executed by the one or more processors, causes the computer system to create: a synchronization module programmed to migrate data from a source data store to a target data store, wherein the synchronization module is configured to control how much of the data is migrated; and a validation module programmed to validate the data between the source data store and the target data store.

According to another aspect, an example method for migration of information can include: migrating data from a source data store to a target data store; controlling how much of the data is migrated; and validating the data between the source data store and the target data store.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for migrating data from a source data store to a target data store.

FIG. 2 shows an example method performed by the system of FIG. 1.

FIG. 3 shows an example user interface of a migration platform of the system of FIG. 1.

FIG. 4 shows another example user interface of the migration platform of the system of FIG. 1.

FIG. 5 shows another example user interface of the migration platform of the system of FIG. 1.

FIG. 6 shows example physical components of the migration platform of the system of FIG. 1.

### DETAILED DESCRIPTION

This disclosure relates to the migration of data.

The concepts described herein provide for migration of data between source and target data stores. This can include an example distributed event-based data migration and validation framework that migrates data from the source data store to the target data store in near real-time and/or reconciles the data in near real-time after successful data migration. This can also involve near real-time validation for successfully migrated and/or synchronized data.

The example data migration activity can be carried out in two phases. An example phase one involves migrating snapshots of the data from the source data store to the target data store. An example phase two then involves migrating the data modified by the incoming real-time traffic by capturing the changes as events.

The real-time migration of data can involve capturing the data that has changed, due to ongoing traffic to the system, as events. These events can be published to a distributed messaging system, which receives these events, extracts the data changes needed at the target data store, applies transformation, and/or saves the changes to the target data store. The transformation can be configurable for each event. Adding or modifying the configuration for an event can be done by just adding required configuration parameters. This can make the migration extensible and adaptable for future data migrations.

There can be various advantages associated with the technologies described herein. For instance, as the data changes are captured and migrated in near real-time, switching or rolling out the traffic becomes seamless and allows the rollout to be carried out in a phased manner. The events, after migrating the data to the target data store, can be sampled and sent for validation, which verifies that the data has been migrated properly. This creates a more robust and flexible system for the data migration.

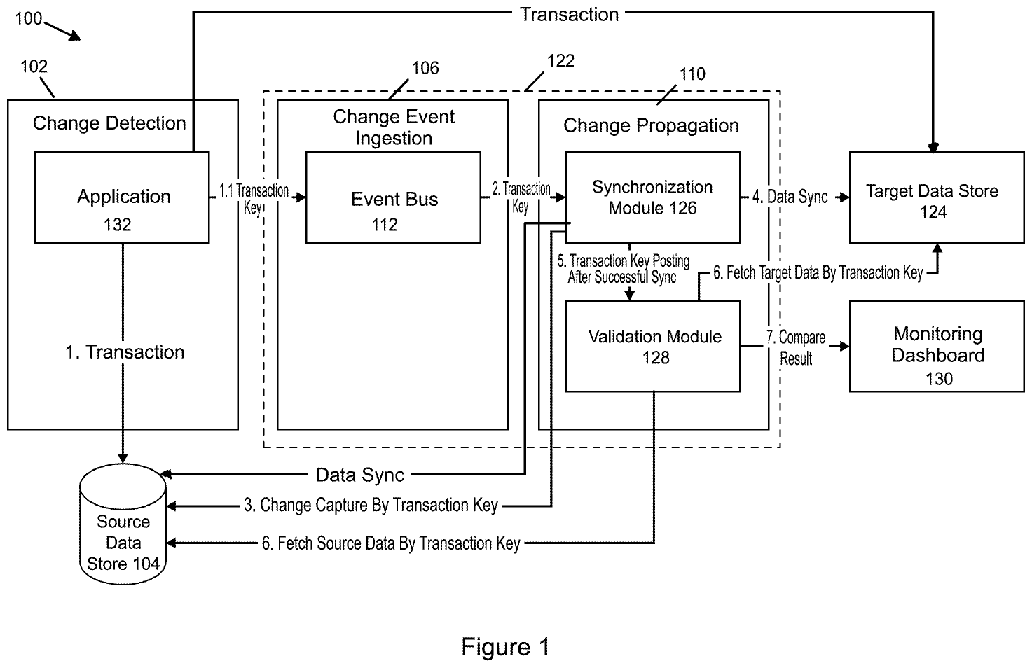

FIG. 1 schematically shows aspects of one example system 100 programmed to migrate data. The system 100 can be a computing environment that includes a plurality of client and server devices. In this instance, the system 100 includes client device 102, a migration device 122, data stores 104, 124, and a monitoring dashboard 130. The client device 102, the migration device 122, the data stores 104, 124, and the monitoring dashboard 130 can communicate through a network to accomplish the functionality described herein.

Each of the devices of the system 100 may be implemented as one or more computing devices with at least one processor and memory. Example computing devices include a mobile computer, a desktop computer, a server computer, or other computing device or devices such as a server farm or cloud computing used to generate or receive data. Although only a few devices are shown, the system 100 can accommodate hundreds or thousands of computing devices.

The example data stores 104, 124 are programmed to store information about the processes of the system 100. As described further herein, the data store 104 functions as the source data store, and the data store 124 functions as the target data store.

The example architecture of the system 100 can be highly extensible to support different data stores. In some examples, the data stores supported include Oracle and MongoDB. However, the system 100 can be extended to support other types of data stores. Further, the system 100 can handle large volumes of data from the data stores 104, 124. This allows the system 100 to be scalable and address different technology choices.

The system 100 is programmed as described herein to migrate data from the data store 104 to the data store 124. This migration is initiated by copying a portion and/or all the data from the data store 104 to the data store 124. As described below, as this migration is taking place, changes made to the data are captured so that the data in the data stores 104, 124 is maintained in a current state.

In the example depicted in FIG. 1, an application 132 on the client device 102 accesses data from the data store 104 through an Application Programming Interface (API) or other mechanism to perform various functions associated with an enterprise. For instance, the system 100 can provide financial services, and the client device 102 can be programmed to access data from the data store 104 to facilitate those financial services.

In some examples, the application 132 of the client device 102 is programmed to transition from accessing data from the data store 104 to accessing data from the data store 124 as the data is migrated from the data store 104 to the data store 124. In other examples, the data is migrated in stages, so the client device 102 can, at some point, access data from either the data store 104 or the data store 124 for at least a period of time during the migration process.

In general, as the client device 102 interacts with the data store 104, data that is changed is captured as events by a change event ingestion module 106 of the migration device 122. These events are published to the migration device 122 to allow synchronization of the data between the data store 104 and the data store 124. To accomplish this publication, the data and associated metadata, including a transaction key, are provided to an event bus 112 of the change event ingestion module 106 for each transaction by the client device 102.

In the examples provided herein, the transaction key is a unique identifier of data stored in the data store 104 and the data store 124. The transaction key can, for instance, be a globally unique identifier (e.g., a value having a certain length) that can be used to identify data. For instance, the transaction key can be a unique number that is used to identified data stored in the source data store and the target data store so that the data can be compared for synchronization and validation, as described further below. Many other configurations are possible.

In one example, the events are captured as JavaScript Object Notation (JSON) events. The change event ingestion module 106 receives the events, including the associated transaction keys, as the events are published by the application 132 running on the client device 102. More specifically, as the application 132 manipulates data within the data store 104, the application also publishes events to the event bus 112 of the change event ingestion module 106. The change event ingestion module 106, in turn, extracts the data changes from the events and provides the event and data information to a change propagation module 110 of the migration device 122, which is described further below.

Generally, the migration device 122 receives the events from the change event ingestion module 106 and assures that the data in the data stores 104, 124 is kept synchronized. For instance, when an event indicating a change at the data store 104 is received by the migration device 122, the migration device 122 applies a transformation and saves the changes to the data store 124. The transformation can be configurable for each event. Adding or modifying the configuration for an event can be done by adding required configuration parameters. This makes the migration device 122 extensible and adaptable for future data migrations.

As the data changes are captured and migrated in near real-time by the migration device 122, switching or rolling out the traffic to the new system becomes seamless and allows the rollout to be carried out in phased manner. These events, after migrating the data to data store 124, can also be sampled and sent for validation by the validation module 128, as described below. If there is any intermittent failure, then retry happens to fix the issue automatically.

More specifically, as the event bus 112 receives events, these events are provided to the change propagation module 110. The change propagation module 110 includes a synchronization module 126 and a validation module 128.

The example synchronization module 126 of the change propagation module 110 is programmed to receive the data associated with each event from the event bus 112, apply any necessary transformations to the data, and synchronize the transformed data with the data store 124. The synchronized data is also associated with the transaction key for the specific event. After a successful synchronization, the synchronization module 126 provides the transaction key associated with the event to the validation module 128.

The synchronization module 126 can use various transformation logic to transform the data that is being migrated. For instance, the following transformations can applied on the data captured from the data store 104 in sequence.

Deduplication of event—each event is identified by a unique identifier and processed once. The change propagation module 110 can be distributed across multiple clusters, and it is possible that more than one instance of the change propagation module 110 picks up the same event. The first instance of the change propagation module 110, which picks the event for processing, will mark the event as ‘picked up’ on the event bus 112. The subsequent instances of the change propagation module 110 that also have picked up the same event, does a lookup. If it is already picked up, then the instance marks the event as duplicate and ignores the event processing. If it is not already picked up, then the instance starts further processing of the event.

Stale Filter—each event is checked for staleness before it is updated in the data store 124. If the data store 124 has the latest changes compared to the data present in the event, the event is ignored. The event is updated only when the data present in the event or the data fetched from the data store 104 is the latest compared to the target data store.

Field Mapping—for each event, there may be a set of fields that needs to be mapped from the data store 104 to the data store 124. The field mapping helps in migrating the data from the source to the target data store.

Data Type—the change propagation module 110 performs the data type transformation if a target data model of the data store 124 requires a field data type to be modified to another.

Custom Processing—the change propagation module 110 also supports custom processing. The change propagation module 110 can be extended to add the custom processing logic.

Sampling for validation—the change propagation module 110 provides the flexibility for sampling the records for validation by the validation module 128. If the sampling is set to 0 percent, then no events are validated. If the sampling is set to 10 percent, then 10 percent of the events are sent for validation by the validation module 128. The validation module 128 processes the sampled events and performs the comparison of fields between source and target data stores, as described further below.

In the examples provided herein, the change propagation module 110 of the migration device 122 is programmed to control how much data is migrated from the data store 104 to the data store 124. For instance, a subset of the data in the data store 104 can be selected to be synchronized. For instance, a user can select certain subset(s) of data to be migrated to the data store 124 by the migration device 122, while leaving other data stored in the data store 104. In one instance, a flag is used to turn migration on and off, although many other configurations are possible.

In another embodiment, the change propagation module 110 of the migration device 122 is programmed to provide a dynamic increase and/or decrease in an amount of data synchronized. For instance, in addition to selection of a subset of data for synchronization, one can select a percentage of data to be synchronized. In one instance, the application 132 can be used to program the increase and/or decrease in the amount of data, although many configurations are possible.

In one example, the change propagation module 110 is programmed to allow for the gradual rollout of data synchronization based upon the amount of increase or decrease defined by the application 132. In this instance, the change propagation module 110 is programmed to start with a small percentage of data that is synchronized to the data store 124, such as 1 percent. The change propagation module 110 thereupon controls the percentage of the data that is synchronized, gradually increasing the amount over time. For instance, the amount of data that is synchronized can be gradually increase to 10 percent, 50 percent, and finally 100 percent.

For instance, the change propagation module 110 can be programmed to start with a small percentage of data that is migrated. After a set time interval, such as one hour, five hours, 10 hours, 1 day, or 7 days, the change propagation module 110 can be programmed to increase the percentage. Over time, the percentage can continue to be increased until a desired percentage is reaches, such as 100 percent.

This gradual rollout of synchronization can be used to minimize the impact on customers and can be used to assure there are no problems with the synchronization. If problems are identified (e.g., by the validation module 128 described below), the change propagation module 110 can halt and/or reverse the migration of the data from the data store 104 to the data store 124 (as described below). In one instance, a flag is used to control the percentage of data that is synchronized, although many other configurations are possible.

In yet another embodiment, the change propagation module 110 of the migration device 122 is programmed to allow for reverse synchronization of data. In other words, data can be synchronized from the data store 104 to the data store 124, as well as from the data store 124 to the data store 104. This is accomplished in part through the ability to define subsets of data that are synchronized (e.g., target data store syncs data 1-100; source data store syncs data 101-200).

In this manner, the application 132 can be programmed to access data from one or both of the data store 104 and the data store 124. As changes are made to the data, those changes are synchronized forward or reverse by the change propagation module 110 to assure the data store 104 and the data store 124 remain coordinated. This can allow for rolling back of data synchronization if problems are detected (e.g., by the validation module 128 described below). Many configurations are possible.

The validation module 128 of the change propagation module 110 is programmed to access the data in the data store 104 and the data store 124 using the transaction key. The validation module 128 can then compare the data from the data store 104 and the data store 124 to assure that the data is consistent between both data stores. The validation module 128 can report the results of this comparison to the monitoring dashboard 130.

For instance, in some examples, the validation module 128 logs any mismatched fields. The validation module 128 can be extended to reconciliation such differences and provide automated error corrections for any data in the data stores 104, 124.

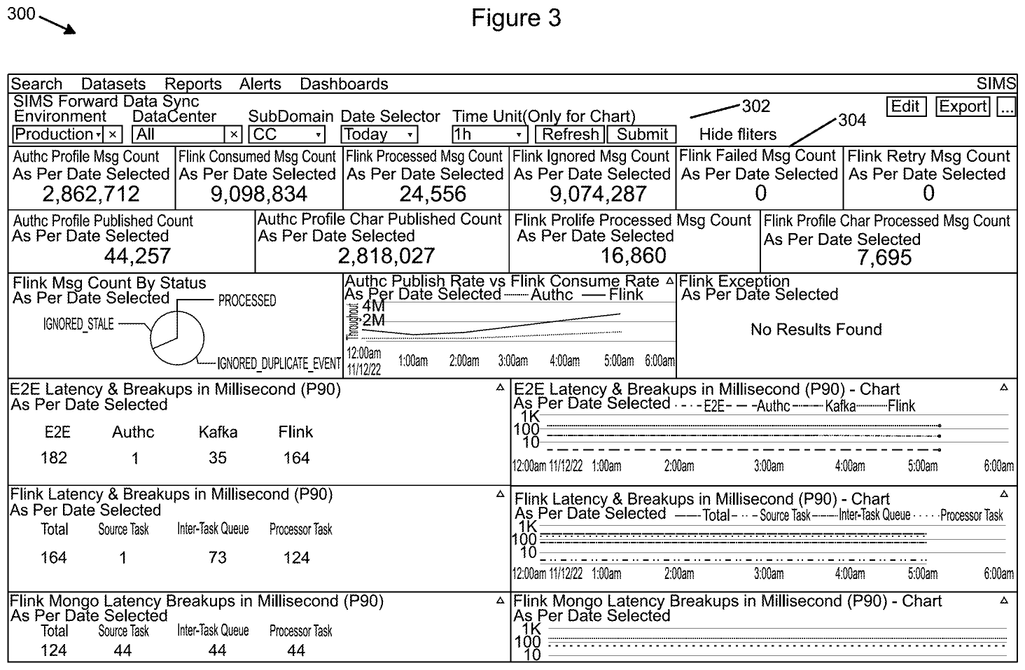

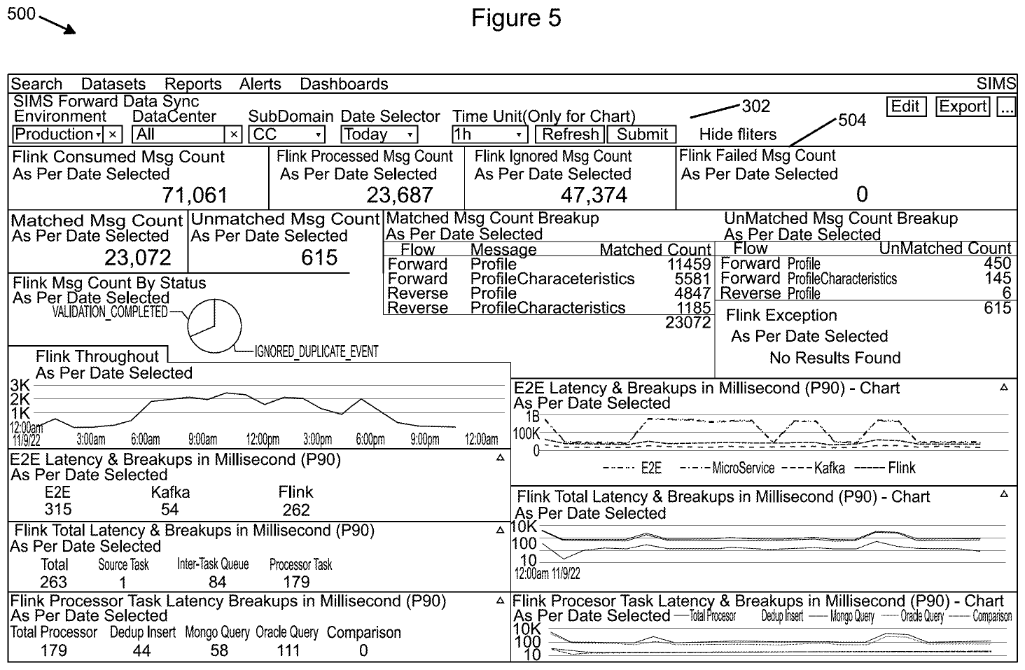

The example monitoring dashboard 130 can be generated by the migration device 122. The monitoring dashboard 130 is programmed to provide one or more user interfaces illustrating the functionality of the migration device 122, such as the status of migration of the data from the data store 104 to the data store 124 and possible mismatches between data. Additional details on these user interfaces are provided at FIGS. 3-5 below.

The migration device 122 can be programmed to handle various types of events. In one example, there are two types of events. A first type of event is a change data event, which holds the data that needs to be migrated to the data store 124. The migration device 122 will use the data from the event and updates the same to the data store 124 after applying necessary transformation.

A second type of event is a change data trigger event, which holds the key identifiers of data from the data store 104. The migration device 122 will query the data store 104 with the key identifiers in the event, capture the actual data that needs to be migrated from the source data store, and update the data store 124 after applying necessary transformation.

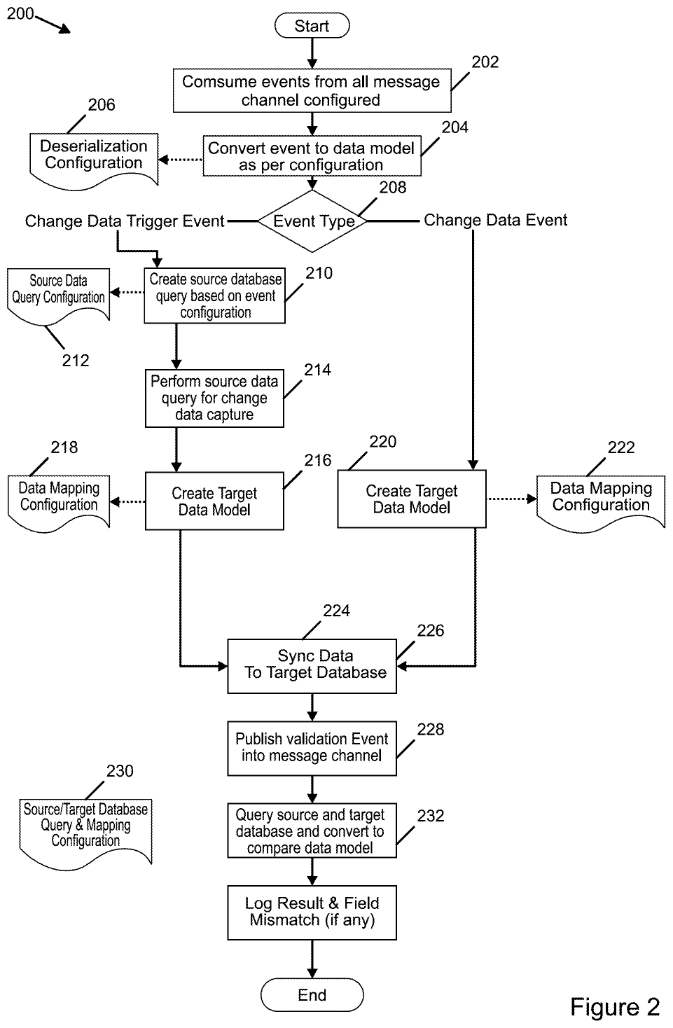

Referring now to FIG. 2, an example method 200 for migrating data is shown. This example method 200 can be performed by the system 100 described above.

At operation 202, events from the system 100 are consumed as data is accessed from the data store. Next, at operation 204, the events are converted to a data model using a deserialization configuration 206. This deserialization configuration 206 is programmed to parse each event and map the event to an event type based on the event identifier. Examples of event types are the change data event and the change data trigger event described above.

Next, at operation 208, a decision is made based upon the type of event. If the type of event is a change data trigger event (i.e., which holds the identifiers of data from the data store 104), control is passed to operation 210, and a query is created for the source data store based upon a source data store query configuration 212. The source data store query configuration 212 defines the query based on the key identifier from the event and maps the source fields to the object definition.

At operation 214, a query is performed in the source data store to capture the data identified by the event that has been changed. Next, at operation 216, the data from the query is used to create a target data model according to a data mapping configuration 218. The data mapping configuration 218 uses this configuration to map the framework's object into the target data store model.

Referring back to operation 208, if the event type is instead a change data event (i.e., which holds the data that needs to be migrated to the data store 124), control is passed to operation 220, where data in the event is used to create a target data model according to a data mapping configuration 222. The data mapping configuration 222 uses this configuration to map the framework's object into the target data store model.

Next, at operation 224, the data is synchronized to the target data store. Upon synchronization, an event is published at operation 226. Next, at operation 228, the validation module 128 queries both the source and target data stores using the transaction key to obtain the data from both data stores. This can be accomplished using a source/target data store query & mapping configuration 230, which is a configuration used to fetch the required data from the source and the target data stores and performs a comparison therebetween.

For instance, in one example, assume that ten fields are synchronized between the data store 104 and the data store 124. The ten fields are accessed from the data store 104 and used to create a first model, and the ten fields are accessed from the data store 124 to create a second model. Both the first and second models are then passed to a model comparator, which compares each field, one-by-one, from the first and second models and captures any differences in values. Many other configurations are possible.

Finally, at operation 232, the results of the comparison of the data are logged. In some examples, notifications are provided when there are mismatched data. For instance, if the data does not match, a notification can be provided on a user interface, such as those provide in FIGS. 3-5.

Referring not to FIGS. 3-5, example user interfaces as generated by the migration device 122 are shown. These example interfaces can be generated as data is synchronized and validated throughout the system 100.

For instance, an interface 300 shown in FIG. 3 provides information as data is synchronized from the data store 104 to the data store 124. In this example, the interface 300 includes a filter control portion 302 that allows the information on the interface 300 to be filtered based upon various criteria. Such example criteria can include: an environment in which the data is being synchronized (e.g., test vs. production); a specific data center and/or domain; and specific dates and/or times.

The interface 300 also includes a statistics portion 304 that lists various metrics associated with the synchronization of the data. These metrics can include a number of events logged by the system 100, including those that have been processed and ignored. For instance, events can be ignored when the event has already been processed or is otherwise stale, as described previously. The statistics portion 304 can also provide different graphs, such as pic charts showing events by process type (e.g., process, ignored, duplicates) or timeline charts showing an event consumption rate over time. Other metrics, such as latency information for the different tasks performed, can also be shown on the statistics portion 304. Many other configurations are possible.

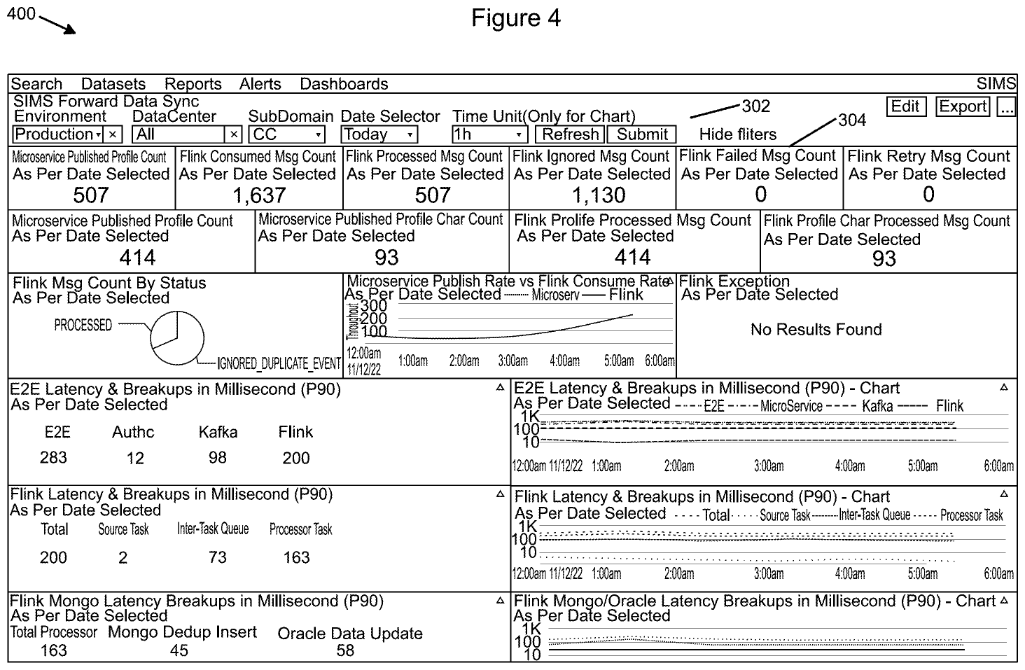

Referring now to FIG. 4, another example interface 400 of the migration device 122 is shown. The interface 400 illustrates information related to the synchronization from the data store 124 back to the data store 104 (i.e., reverse synchronization). The interface 400 can be configured in a manner similar to that of the interface 300, including the filter control portion 302 and the statistics portion 304.

Referring now to FIG. 4, another example interface 400 of the migration device 122 is shown. In this example, the interface 400 provides information about the validation between the data in the data stores 104, 124. This can include the filter control portion 302 and a statistics portion 504. The statistics portion 504 lists various metrics associated with the validation of the data. These metrics can include a number of validation events logged by the system 100, including those that have been processed and ignored. The statistics portion 504 can also provide different graphs, such as pie charts showing validation events by process type (e.g., process, ignored, duplicates) or timeline charts showing an event consumption rate over time. Other metrics, such as latency information for the different tasks performed, can also be shown on the statistics portion 504. Many other configurations are possible.

The statistics portion 504 of the interface 500 can also list a number of exceptions that have occurred, signifying when data does not match between the data stores 104, 124. In some examples, the interface 500 can also provide specifics on the mismatched data. For instance, the interface 500 can provide access to one or more log files that list the data that is mismatched between the data stores 104, 124. Many other configurations are possible.

The example system 100 described herein can be used in various applications. A few examples follow.

In a first example, the system 100 can be used as a part of application modernization, where an existing application is migrated from legacy tech stack (e.g., monolith, RDBMS) to modern tech stack (e.g., microservice, Document Data store). In this example, the entire application domain is broken down into multiple subdomains using Domain Driven Design (DDD). These subdomains are migrated one after another using a strangler pattern.

Before each subdomain is deployed as microservice, snapshot data-migration is performed and then followed by real-time data change capture which enables the synchronization of data changes from the source data store to the target data store. Once the microservice goes live, there is routing of client traffic in incremental fashion, like 1 percent, 10 percent, 50 percent, 100 percent, using a canary deployment.

While handling traffic, microservice updates are stored in the target data store. In a contingency scenario, there is a need for source data store to be kept up to date with target data store in real-time, so rollback can be done at any given instance. This is accomplished using reverse synchronization.

In a second example, the system 100 can be used as part of cloud adoption, where existing API application moved from on-premises to private/public cloud. Before application is deployed into cloud, snapshot data-migration is performed and then followed by real-time data change capture which enables the synchronization of data changes from the on-premises data store (e.g., Oracle) to the target cloud data store (e.g., Azure Cosmos).

Once the API application goes live in the cloud, there is routing of client traffic in incremental fashion, like 1 percent, 10 percent, 50 percent, 100 percent using a canary deployment. While handling traffic, new cloud API application updates cloud data store. In a contingency scenario, there is a need for on-premises data store to be kept up to date with cloud data store in real-time so rollback can be done at any given instance. This is accomplished using reverse synchronization.

In a third example, the system 100 can be used as a part of a phased rollout, where only a few critical business features are prioritized and migrated from a legacy tech stack (e.g., monolith, on-premises) to a modern tech stack (e.g., microservice, cloud) to meet high scalability requirement. The other remaining features continue to remain in the legacy tech stack but there is a dependency on those critical feature data as well. These critical business features are migrated one after another using a strangler pattern.

Before each feature deployed as microservice on the cloud, snapshot data-migration is performed and then followed by real-time data change capture to synchronize data changes from the source legacy data store and update to the target modern data store. Once new features go live, there is routing of client traffic in incremental fashion, like 1 percent, 10 percent, 50 percent, 100 percent, using canary deployment. While handling traffic, new application updates the target feature data store and there is a real-time data capture required from the target data store to the source data store (e.g., using reverse synchronization) for legacy features to continue make use of it.

There are many other possible example applications of the disclosed technologies.

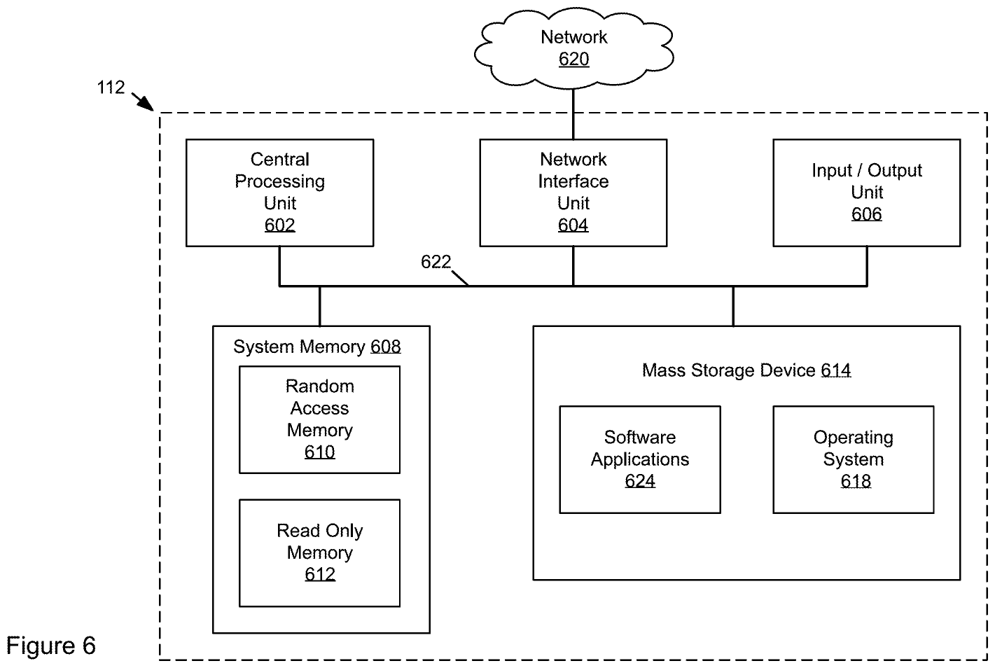

As illustrated in the embodiment of FIG. 6, the example migration device 122, which provides the functionality described herein, can include at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system containing the basic routines that help transfer information between elements within the migration device 122, such as during startup, is stored in the ROM 612. The migration device 122 further includes a mass storage device 614. The mass storage device 614 can store software instructions and data. A central processing unit, system memory, and mass storage device similar to that shown can also be included in the other computing devices disclosed herein.

The mass storage device 614 is connected to the CPU 602 through a mass storage controller (not shown) connected to the system bus 622. The mass storage device 614 and its associated computer-readable data storage media provide non-volatile, non-transitory storage for the migration device 122. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the migration device 122.

According to various embodiments of the invention, the migration device 122 may operate in a networked environment using logical connections to remote network devices through network 620, such as a wireless network, the Internet, or another type of network. The network 620 provides a wired and/or wireless connection. In some examples, the network 620 can be a local area network, a wide area network, the Internet, or a mixture thereof. Many different communication protocols can be used.

The migration device 122 may connect to network 620 through a network interface unit 604 connected to the system bus 622. It should be appreciated that the network interface unit 604 may also be utilized to connect to other types of networks and remote computing systems. The migration device 122 also includes an input/output controller 606 for receiving and processing input from a number of other devices, including a touch user interface display screen or another type of input device. Similarly, the input/output controller 606 may provide output to a touch user interface display screen or other output devices.

As mentioned briefly above, the mass storage device 614 and the RAM 610 of the migration device 122 can store software instructions and data. The software instructions include an operating system 618 suitable for controlling the operation of the migration device 122. The mass storage device 614 and/or the RAM 610 also store software instructions and applications 624, that when executed by the CPU 602, cause the migration device 122 to provide the functionality of the migration device 122 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for migration of information, comprising:
one or more processors; and
non-transitory computer-readable storage media encoding instructions which, when executed by the one or more processors, causes the computer system to create:
a synchronization module programmed to migrate data from a source data store to a target data store, wherein the synchronization module is configured to control how much of the data is migrated; and
a validation module programmed to validate the data between the source data store and the target data store.

2. The computer system of claim 1, wherein the synchronization module is further programmed to migrate a percentage of the data from the source data store to the target data store.

3. The computer system of claim 2, wherein the synchronization module is further programmed to increase the percentage of the data that is migrated over time.

4. The computer system of claim 3, wherein the increase is after a set time interval.

5. The computer system of claim 1, wherein the synchronization module is further programmed to allow for selection of a subset of the data that is migrated from the source data store to the target data store.

6. The computer system of claim 1, wherein the validation module is further programmed to compare source data from the source data store with target data from the target data store to perform validation.

7. The computer system of claim 1, comprising further instructions which, when executed by the one or more processors, causes the computer system to create an event bus to receive an event for each transaction with the source data store.

8. The computer system of claim 7, wherein the event for each transaction includes a transaction key that unique identifies transaction data associated with the event.

9. The computer system of claim 8, wherein the validation module is further programmed to:
access source data from the source data store using the transaction key;
access target data from the target data store using the transaction key; and
compare the source data and the target data for validation.

10. The computer system of claim 1, wherein the synchronization module is further programmed to perform reverse synchronization where the data is migrated from the target data store to the source data store.

11. A method for migration of information, comprising:
migrating data from a source data store to a target data store;
controlling how much of the data is migrated; and
validating the data between the source data store and the target data store.

12. The method of claim 11, further comprising defining a percentage of the data that is migrated from the source data store to the target data store.

13. The method of claim 12, further comprising increasing the percentage of the data that is migrated over time.

14. The method of claim 13, wherein the increase is after a set time interval.

15. The method of claim 11, further comprising allowing for selection of a subset of the data that is migrated from the source data store to the target data store.

16. The method of claim 11, further comprising comparing source data from the source data store with target data from the target data store to perform validation.

17. The method of claim 11, further comprising creating an event bus to receive an event for each transaction with the source data store.

18. The method of claim 17, wherein the event for each transaction includes a transaction key that unique identifies transaction data associated with the event.

19. The method of claim 18, further comprising:
accessing source data from the source data store using the transaction key;
accessing target data from the target data store using the transaction key; and
comparing the source data and the target data for validation.

20. The method of claim 11, further comprising performing reverse synchronization where the data is migrated from the target data store to the source data store.
